(19) United States
(12) Patent Application Publication
(10) Pub. No.: US 2021/0223044 A1
(43) Pub. Date: Jul. 22, 2021

(54) PHYSICAL-ADJUSTMENT-FREE LASER LEVEL GAUGE AND METHOD FOR ASSEMBLING AND PROCESSING THE SAME

(71) Applicant: ODA Electronics Limited, Dongguan (CN)

(72) Inventors: Yongqiang CHEN, Dongguan (CN); Zhenhong LEI, Taishan (CN); Mingling MAO, Heze (CN)

(21) Appl. No.: 16/099,190

(22) PCT Filed: Feb. 27, 2018
(86) PCT No.: PCT/CN2018/077308

§ 371 Date: Nov. 6, 2018

(30) Foreign Application Priority Data
Feb. 7, 2018 (CN) 201810122262.3

(51) Int. Cl. G01C 15/00; G01C 15/12

(52) U.S. Cl. CPC G01C 15/006; G01C 15/12

(57) ABSTRACT

A physical-adjustment-free laser level gauge comprising a core assembly and a cover assembly; the core assembly further comprises a core frame; connecting studs are fixed to the core frame; the cover assembly further comprises a cover body; rigid nut columns are fixed in the cover body through sealing glue; the rigid nut columns are connected with the connecting studs through screws; a light-emitting mechanism mounting seat is fixed on the core frame; the light-emitting mechanism mounting seat is provided with mounting convex blocks; the light-emitting mechanism comprises an annular protrusion mounting portion; the cover body is provided with a rotation mechanism and a refraction mechanism.

### TECHNICAL FIELD OF THE INVENTION

The present invention relates to the technical field of level gauges, and more particularly, to a physical-adjustment-free laser level gauge and a method for assembling and processing the same.

### BACKGROUND OF THE INVENTION

A laser level gauge is an apparatus capable of guiding the laser beam emitted by the laser-emitting device into its telescopic tube, thereby enabling the laser beam to be emitted along the direction of collimation axis. Laser level gauges are used wherever accurate verticals and horizontals are required. The vertical laser beam emitted by the laser-emitting device can be refracted and rotated through the laser level gauge, thus being emitted in different horizontal directions of the same axis at different moments. Laser beams emitted at different moments form a laser collimation plane parallel to the horizontal plane. When the rotation frequency is high enough, human eyes can receive a laser plane. Laser level gauges are widely applied in surveying, engineering and construction.

In the prior art, most of the traditional laser level gauges sold on the market adopts an integrated base with different mounting positions. Various components need to be mounted to the aforesaid base, greatly increasing the assembling difficulty. As a result, the accuracy of the laser collimation plane formed by the laser level gauge can be seriously affected even by a slightest assembling error. Moreover, the finished product can only operate normally after a complicated adjustment. Meanwhile, as all the mounting positions on the base are formed in one time, mismatches between the mounting positions and the components inevitably lead to assembling errors. Even worse, the assembling errors and the processing errors of the components themselves can be accumulated, resulting in a low standard reference accuracy of the laser collimation plane formed by the laser level gauge.

### SUMMARY OF THE INVENTION

The purpose of the present invention is to solve the shortcomings in the prior art by providing a physical-adjustment-free laser level gauge and a method for assembling and processing the same. As the two major assemblies of the laser level gauge are in a rigid connection, the assembling difficulty can be effectively reduced. Moreover, it's unnecessary to adjust the finished product. According to the reliable assembling and processing steps, various errors can be prevented from being accumulated. Thus, the accuracy of the laser collimation plane emitted by the present invention can be ensured.

To achieve the above purpose, the present invention adopts the following technical solution:

A physical-adjustment-free laser level gauge comprising a core assembly and a cover assembly, wherein the core assembly and the cover assembly are fixedly connected; the core assembly further comprises a core frame; m connecting studs are fixed to the core frame, wherein m is an integer larger than or equal to 3; the core frame is provided with an x-axis level bubble, a y-axis level bubble and a z-axis level bubble; the cover assembly further comprises a cover body; m rigid nut columns are fixed in the cover body through sealing glue; the rigid nut columns protrude from the cover body, and are connected with the connecting studs through screws;

A light-emitting mechanism mounting seat is fixed on the core frame, and a light-emitting mechanism is connected with the light-emitting mechanism mounting seat through screws; the light-emitting mechanism mounting seat is provided with n mounting convex blocks, wherein n is an integer larger than or equal to 3; the mounting convex block is provided with a first screw hole, and the first screw hole extends throughout the mounting convex block and the core frame; the light-emitting mechanism comprises a light source support shell and a light source that is fixed in the light source support shell; an annular protrusion mounting portion is fixed on one side of the mounting disc that is far away from the light-emitting side of the light source; an inner ring of the annular protrusion mounting portion is spaced from the light source support shell; n second screw holes are formed in the annular protrusion mounting portion; the second screw hole also extends throughout the mounting disc, and is matched with the first screw hole;

A ball shaft mounting seat is arranged on the cover body, and a ball shaft is fixed in the ball shaft mounting seat; a rotation mechanism is arranged in the ball shaft, and a refraction mechanism is fixed at the output end of the top of the rotation mechanism;

The end surface of the connecting stud, the end surface of the rigid nut column, the end surface of the mounting convex block and the end surface of the annular protrusion mounting portion are parallel to the xy-plane; the optical axis of the light source and the rotation axis of the rotation mechanism are parallel to the z-axis, and the optical axis of the light source is coaxial with the rotation axis of the rotation mechanism.

In another aspect of the present invention, the height of the mounting convex block that protrudes from the light-emitting mechanism mounting seat is 0.5-1 mm. All mounting convex blocks are distributed in a circle with the diameter of P, wherein P≥27 mm.

In another aspect of the present invention, the height of the annular protrusion mounting portion that protrudes from the mounting disc is 3.5-4 mm, wherein the diameter of the outer ring of the annular protrusion mounting portion is larger than or equal to 27 mm.

In another aspect of the present invention, the rotation mechanism comprises a hollow rotation shaft, and a rotation disc is fixed to one end of the hollow rotation shaft that is close to the core assembly. The other end of the hollow rotation shaft is the output end of the rotation mechanism. The hollow rotation shaft is installed in the ball shaft through a bearing. The rotation mechanism further comprises a rotation driving motor, and the output end of the rotation driving motor is connected with the rotation disc through a belt.

In another aspect of the present invention, the radius of the columnar inner cavity of the hollow rotation shaft is defined as R, and the radius of the light beam emitted by the light source is defined as r, wherein r≤R.

In another aspect of the present invention, a coding magnetic disk is fixed on the rotation disc, and a photoelectric sensor is arranged in the cover body. The sensing portion of the photoelectric sensor is opposite to the coding magnetic disk.

In another aspect of the present invention, the ball end of the ball shaft is connected with a ball limiting block, and a clamping plate is arranged between the ball limiting block and the cover body. The clamping plate is provided with a gourd-shaped notch, and the small-radius part of the notch is located in the center of the clamping plate. The clamping plate is connected with the cover body through clamping connection mechanisms.

A method for assembling and processing the physical-adjustment-free laser level gauge, comprising the steps of:

Step 1: obtaining the core frame, the cover body and the light-emitting mechanism through a machining process;

Step 2: fixing the x-axis level bubble, the y-axis level bubble and the z-axis level bubble in the core frame;

Step 3: placing the core frame into a milling machine, and leveling the core frame through the x-axis level bubble, the y-axis level bubble and the z-axis level bubble; subsequently, processing the end surfaces of the connecting studs and that of the mounting convex blocks via a milling process, thus enabling the end surfaces of the connecting studs and that of the mounting convex blocks to be parallel to the xy-plane;

Step 4: clamping the light-emitting mechanism into a rotary calibration device, and placing a CCD screen at a distance of 80-120 m away from the light-emitting mechanism; propelling the light-emitting mechanism to rotate through the rotary calibration device, and adjusting the position of the light-emitting mechanism until the projection of the rotating light-emitting mechanism on the CCD screen is changed from a circle into a dot, wherein the CCD screen obtains accurate images from a computer connected therewith, and the milling machine processes the end surface of the annular protrusion mounting portion of the light-emitting mechanism having an adjusted angle, thus ensuring that the end surface of the annular protrusion mounting portion is parallel to the xy-plane;

Step 5: fixing the ball shaft in the ball shaft mounting seat, and fixing the rigid nut columns in the cover body through sealing glue; subsequently, fixing the cover body in the milling machine through the interaction between the ball shaft and the clamping fixture, and processing the end surfaces of the rigid nut columns via a milling process, thus ensuring that the end surfaces of the rigid nut columns are parallel to the xy-plane;

Step 6: tightly attaching the end surfaces of the mounting convex blocks to the end surface of the annular protrusion mounting portion, and fixing the light-emitting mechanism in the light-emitting mechanism mounting seat through screws; subsequently, installing the rotation mechanism into the ball shaft, and fixing the refraction mechanism to the output end of the rotation mechanism; tightly attaching the end surfaces of the connecting studs to the end surfaces of the rigid nut column, and fixing the cover body in the core frame through screws.

In another aspect of the present invention, in steps 3 and 4, the diameter of the end surface of the mounting convex block is defined as p, and the edge length of the milling cutter in the milling machine is defined as L, wherein p≤L. The width of the end surface of the annular protrusion mounting portion is defined as q, and q≤L.

In another aspect of the present invention, in steps 3, 4 and 5, the outer diameter of the surface to be processed can be designed according to the formula j=i/tank, wherein i is the processing accuracy of the milling machine, j is the outer diameter of the surface to be processed, and k is the processing and forming accuracy, wherein 0≤k≤37″.

Compared with the prior art, the present invention has the following advantages: According to the present invention, the core assembly and the cover assembly can be pre-assembled, preventing all components from being assembled in one time. Thus, the assembling difficulty can be effectively reduced. The core assembly and the cover assembly are in a rigid connection, and are further provided with processing foundations for facilitating the subsequent treatment. Therefore, the accuracy of the present invention can be significantly enhanced. Furthermore, the level adjustment mechanisms are fixed in the core frame before the end surfaces of the mounting convex blocks in the light-emitting mechanism mounting seat are processed. Thus, the adjustment result of the level adjustment mechanism can be directly fed back to the mounting convex blocks, preventing the assembling and processing errors from being accumulated. Likewise, the end surfaces of the light-emitting mechanism and the cover body are processed after their semi-finished products are assembled. As the errors of every position can be significantly reduced, the present invention can be directly used without adjustment, and a higher accuracy of the laser collimation plane emitted by the present invention can be achieved.

### BRIEF DESCRIPTION OF THE DRAWINGS

To clearly expound the technical solution of the present invention, the drawings and embodiments are hereinafter combined to illustrate the present invention. Obviously, the drawings are merely some embodiments of the present invention and those skilled in the art can associate themselves with other drawings without paying creative labor.

FIG. 1 is a three-dimensional diagram of the present invention;

FIG. 2 is a structural diagram illustrating the separated core assembly and the cover assembly of the present invention;

FIG. 3 is an explosive view of the present invention;

FIG. 4 is a top view of the present invention;

FIG. 5 is a sectional view along line A-A′ in FIG. 4 of the present invention;

FIG. 6 is a structural diagram after the core frame and the light-emitting mechanism mounting seat of the present invention are assembled;

FIG. 7 is a structural diagram of the cover body and the ball shaft of the present invention;

FIG. 8 is a top view of the light-emitting mechanism of the present invention;

FIG. 9 is a sectional view along line B-B′ in FIG. 8 of the present invention.

### MARKING INSTRUCTIONS OF THE DRAWINGS

Core Assembly 10, Core Frame 11, Connecting Stud 12, X-axis Level Bubble 13, Y-axis Level Bubble 14, Z-axis Level Bubble 15, Cover Assembly 20, Cover Body 21, Ball Shaft Mounting Seat 211, Ball Shaft 212, Rigid Nut Column 22, Light-emitting Mechanism Mounting Seat 30, Mounting Convex Block 31, The First Screw Hole 311, Light-emitting Mechanism 40, Light Source Support Shell 41, Light Source 42, Mounting Disc 43, Annular Protrusion Mounting Portion 44, The Second Screw Hole 441, Hollow Rotation Shaft 51, Rotation Disc 52, Coding Magnetic Disk 521, Bearing 53, Rotation Driving Motor 54, Belt 55, Refraction Mechanism 60, Ball Limiting Block 71, Clamping Plate 72, Notch 721, Clamping Connection Mechanism 73

### DETAILED DESCRIPTION OF THE INVENTION

Drawings and detailed embodiments are combined hereinafter to elaborate the technical principles of the present invention.

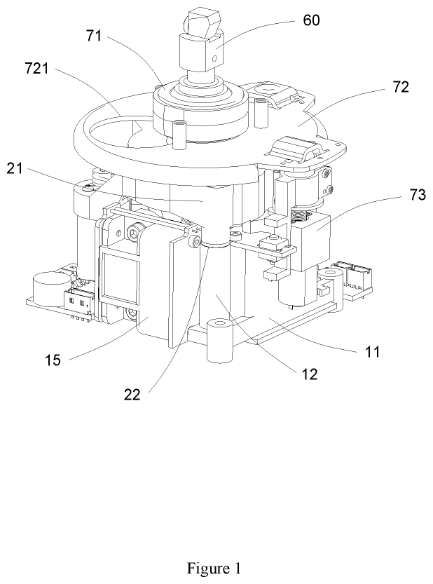

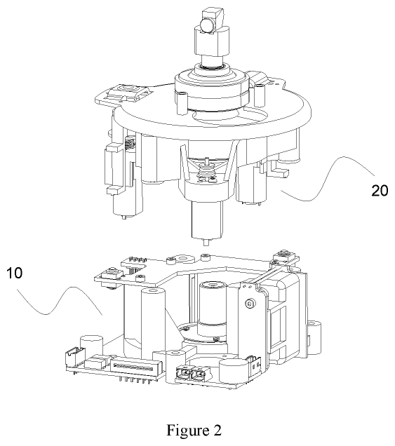

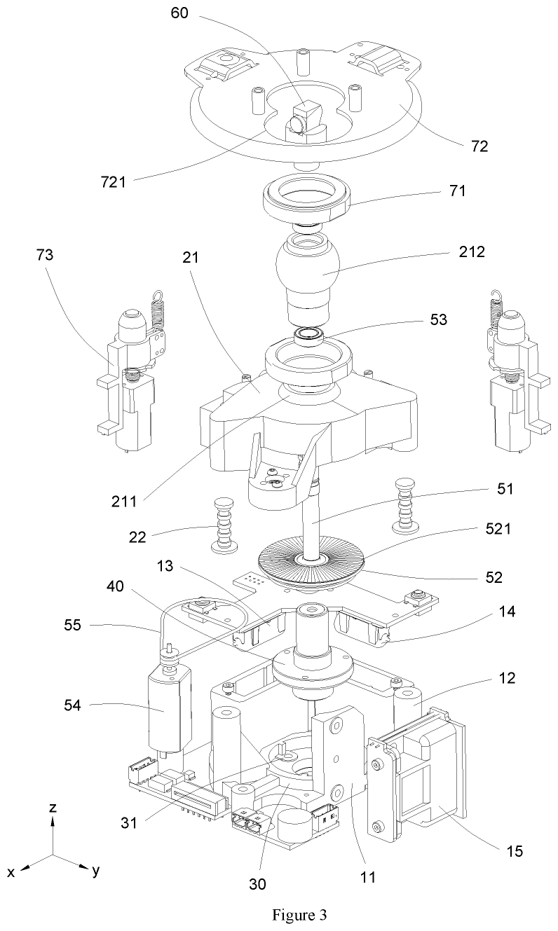

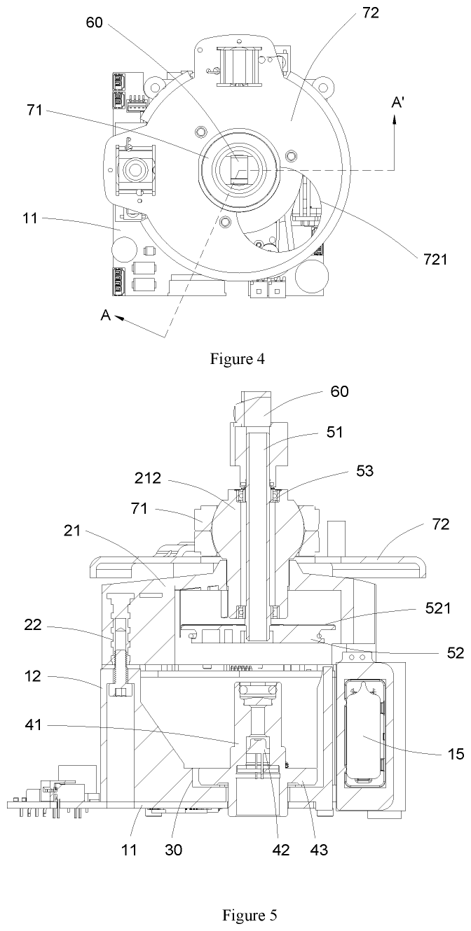

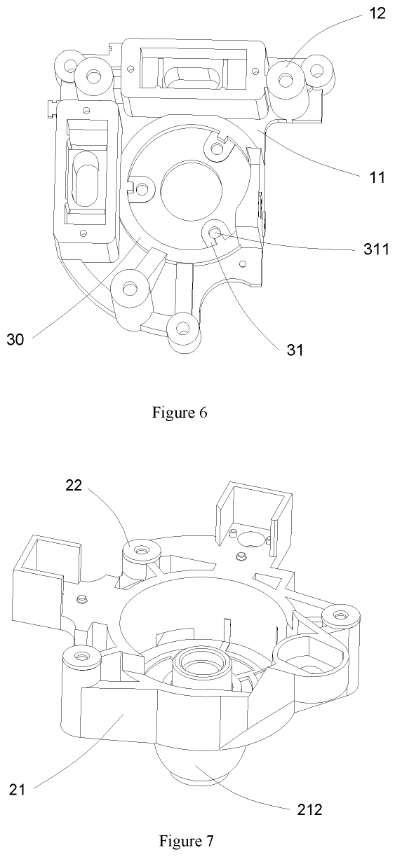

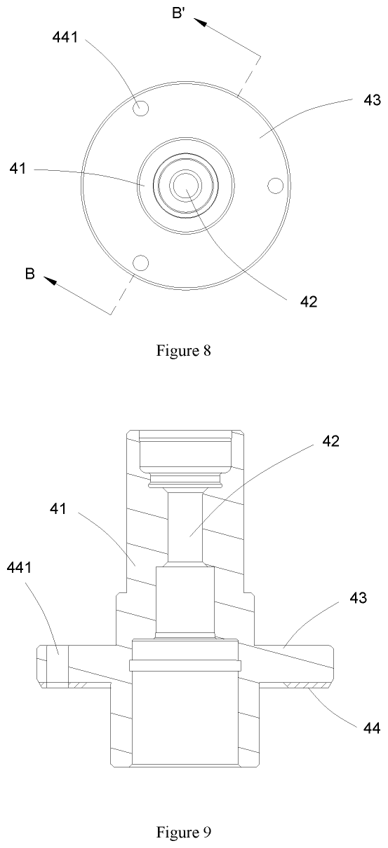

As shown in FIGS. 1-9, the present invention discloses a physical-adjustment-free laser level gauge, which comprises a core assembly 10 and a cover assembly 20, wherein the core assembly 10 and the cover assembly 20 are fixedly connected. The core assembly 10 further comprises a core frame 11. M connecting studs 12 are fixed to the core frame 11, wherein m is an integer larger than or equal to 3. The core frame 11 is provided with an x-axis level bubble 13, a y-axis level bubble 14 and a z-axis level bubble 15. The cover assembly 20 further comprises a cover body 21. M rigid nut columns 22 are fixed in the cover body 21 through sealing glue. Preferably, the rigid nut column 22 is a brass nut column. The rigid nut column 22 protrudes out from the cover body 21, and is connected with the connecting stud 12 through a screw.

A light-emitting mechanism mounting seat 30 is fixed on the core frame 11, and a light-emitting mechanism 40 is connected with the light-emitting mechanism mounting seat 30 through screws. The light-emitting mechanism mounting seat 30 is provided with n mounting convex blocks 31, wherein n is an integer larger than or equal to 3. The mounting convex block 31 is provided with a first screw hole 311, and the first screw hole 311 extends throughout the core frame 11. The light-emitting mechanism 40 comprises a light source support shell 41 and a light source 42 that is fixed in the light source support shell 41. Preferably, the light source 42 is a laser diode. An annular protrusion mounting portion 44 is fixed on one side of the mounting disc 43 that is far away from the light-emitting side of the light source 42. An inner ring of the annular protrusion mounting portion 44 is spaced from the light source support shell 41, thus preventing the light source support shell 41 from impeding the subsequent processing. N second screw holes 441 are formed in the annular protrusion mounting portion 44. The second screw hole 441 also extends throughout the mounting disc 43, and is matched with the first screw hole 311. The mounting convex block 31 and the annular protrusion mounting portion 44 both protrude from a plane where they are located so that the subsequent processing can be facilitated.

A ball shaft mounting seat 211 is arranged on the cover body 21, and a ball shaft 212 is fixed in the ball shaft mounting seat 211. A rotation mechanism is arranged in the ball shaft 212, and a refraction mechanism 60 is fixed at the output end of the top of the rotation mechanism. Preferably, one end of the ball shaft 212 is spherical, and the other end of the ball shaft 212 is shaft-shaped. The center of the ball shaft 212 is a channel with two ends communicated with each other. The refraction mechanism 60 further comprises a pentagonal prism and a pentagonal prism mounting seat.

The end surface of the connecting stud 12, the end surface of the rigid nut column 22, the end surface of the mounting convex block 31 and the end surface of the annular protrusion mounting portion 44 are parallel to the xy-plane. The optical axis of the light source 42 and the rotation axis of the rotation mechanism are parallel to the z-axis, and the optical axis of the light source 42 is coaxial with the rotation axis of the rotation mechanism.

The operating process of the physical-adjustment-free laser level gauge of the present invention is the following:

The levelness of the present invention is adjusted through the x-axis level bubble 13, the y-axis level bubble 14 and the z-axis level bubble 15. The light source 42 in the light-emitting mechanism 40 emits thin light beams to the refraction mechanism 60 above, and the rotation mechanism propels the refraction mechanism 60 to rotate. The rotating refraction mechanism 60 refracts the thin light beams towards the periphery of the horizontal plane, thereby forming a laser collimation plane parallel to the horizontal plane.

According to the present invention, the core assembly 10 and the cover assembly 20 can be pre-assembled, preventing all components from being assembled in one time. Thus, the assembling difficulty can be effectively reduced. The core assembly 10 and the cover assembly 20 are in a rigid connection, and are further provided with processing foundations for facilitating the subsequent treatment. Therefore, the accuracy of the present invention can be significantly enhanced.

In this embodiment, in order to improve the accuracy of the present invention, the height of the mounting convex block 31 that protrudes from the light-emitting mechanism mounting seat 30 is 0.5-2 mm. All mounting convex blocks 31 are distributed in a circle with the diameter of P, wherein P≥27 mm. The height of the annular protrusion mounting portion 44 that protrudes from the mounting disc 43 is 0.5-1 mm, wherein the diameter of the outer ring of the annular protrusion mounting portion 44 is larger than or equal to 27 mm. The protruding height of the mounting convex block 31 and the annular protrusion mounting portion 44 is 3.5-4 mm. By means of this design, a foundation that does not impede the assembly of other components and can be easily processed is provided to the subsequent surface milling process. The calculation formula of the outer diameter of the surface to be processed is j=i/tank, wherein i is the processing accuracy of the milling machine, j is the outer diameter of the surface to be processed, and k is the processing and forming accuracy. When using a milling machine with the accuracy of 0.005 mm, the rotation diameter of the milling cutter or the rotation diameter of the processing surface must be larger than or equal to 27 mm, wherein the requirement of the processing and forming accuracy is 0≤k≤37″.

In this embodiment, the rotation mechanism comprises a hollow rotation shaft 51, and a rotation disc 52 is fixed to one end of the hollow rotation shaft 51 that is close to the core assembly 10. The other end of the hollow rotation shaft 51 is the output end of the rotation mechanism. The hollow rotation shaft 51 is installed in the ball shaft 212 through a bearing 53. The rotation mechanism further comprises a rotation driving motor 54, and the output end of the rotation driving motor 54 is connected with the rotation disc 52 through a belt 55. The rotation driving motor 54 drives the hollow rotation shaft 51 to rotate through the belt 55, thereby enabling the refraction mechanism 60 on the hollow rotation shaft 51 to rotate together.

In this embodiment, the radius of the columnar inner cavity of the hollow rotation shaft 51 is defined as R, and the radius of the light beam emitted by the light source 42 is defined as r, wherein r≤R. According to this design, the shape and/or direction of the light beam emitted by the light source 42 can be prevented from being affected by the hollow rotation shaft 51.

In this embodiment, a coding magnetic disk 521 is fixed on the rotation disc 52, and a photoelectric sensor is arranged in the cover body 21. The sensing portion of the photoelectric sensor is opposite to the coding magnetic disk 521. The coding magnetic disk 521 is provided with black and white inter-phase lines, thus enabling pulse signals generated by a rotation coding disk 62 to be transmitted to the photoelectric sensor. Thus, the rotation speed of the rotation disc can be monitored and regulated.

In this embodiment, the ball end of the ball shaft 212 is connected with a ball limiting block 71, and a clamping plate 72 is arranged between the ball limiting block 71 and the cover body 21. The clamping plate 72 is provided with a gourd-shaped notch 721, and the small-radius part of the notch 721 is located in the center of the clamping plate 72. The clamping plate 72 is connected with the cover body 21 through clamping connection mechanisms 73, wherein the number of the clamping connection mechanisms 73 is at least two. The clamping plate 72 mainly plays a role in protecting, and the small-radius part of the gourd-shaped notch 721 is used for clamping the ball limiting block 71. The large-radius part of the gourd-shaped notch 721 is used for allowing the ball limiting block 71 to pass through. The clamping connection mechanism 73 comprises a clamping motor, a clamping block and a hook spring. The clamping motor is arranged in the cover body, and the clamping block is in threaded connection with the output end of the clamping motor. A limiting column matched with the clamping block is arranged on a side surface of the cover body 21, and the limiting column limits the rotation of the clamping block. One end of the hook spring is connected with the clamping block, and the other end of the hook spring is connected with the clamping plate 72. When the clamping motor rotates forwards to interact with the limiting column, the clamping block is propelled to descend, and the position of the clamping plate 72 is fixed by the tensioned hook spring. In contrast, when the clamping motor rotates reversely to interact with the limiting column, the clamping block is propelled to ascend, and the hook spring is restored to its original length to release the clamping plate 72.

A method for assembling and processing the aforesaid physical-adjustment-free laser level gauge, comprising the steps of:

Step 1: obtaining the core frame 11, the cover body 21 and the light-emitting mechanism 40 through a machining process, wherein the core frame 11, the cover body 21 and the light-emitting mechanism 40 are respectively provided with mounting positions for pre-assembling;

Step 2: fixing the x-axis level bubble 13, the y-axis level bubble 14 and the z-axis level bubble 15 in the core frame 11, wherein the x-axis level bubble 13, the y-axis level bubble 14 and the z-axis level bubble 15 are level adjustment mechanisms;

Step 3: placing the core frame 11 into a milling machine, and leveling the core frame 11 through the x-axis level bubble 13, the y-axis level bubble 14 and the z-axis level bubble 15; subsequently, processing the end surfaces of the connecting studs 12 and that of the mounting convex blocks 31 via a milling process, thus enabling the end surfaces of the connecting studs 12 and that of the mounting convex blocks 31 to be parallel to the xy-plane, the end surfaces of all the connecting studs 12 to be coplanar, and the end surfaces of all the mounting convex blocks 31 to be coplanar; namely, enabling the level adjustment mechanisms to directly act on the mounting convex blocks 31 and the connecting studs 12, thus avoiding the failure of adjusting the mounting convex blocks 31 and the connecting studs 12 caused by various factors;

Step 4: clamping the light-emitting mechanism 40 into a rotary calibration device, and placing a CCD screen at a distance of 80-120 m away from the light-emitting mechanism 40; propelling the light-emitting mechanism 40 to rotate through the rotary calibration device, and adjusting the position of the light-emitting mechanism 40 until the projection of the rotating light-emitting mechanism 40 on the CCD screen is changed from a circle into a dot, wherein the CCD screen obtains accurate images from a computer connected therewith, and the milling machine processes the end surface of the annular protrusion mounting portion 44 of the light-emitting mechanism 40 having an adjusted angle, thus ensuring that the end surface of the annular protrusion mounting portion 44 is parallel to the xy-plane, and the end surface of the annular protrusion mounting portion 44 is perpendicular to the optical axis of the light beam emitted by the light source 42;

Step 5: fixing the ball shaft 212 in the ball shaft mounting seat 211, and fixing the rigid nut columns 22 in the cover body 21 through sealing glue; subsequently, fixing the cover body 21 in the milling machine through the interaction between the ball shaft 212 and the clamping fixture, and processing the end surfaces of the rigid nut columns 22 via a milling process, thus ensuring that the end surfaces of the rigid nut columns 22 are parallel to the xy-plane, the axle center of the ball shaft 212 is perpendicular to the end surfaces of the rigid nut columns, and the end surfaces of all the rigid nut columns are coplanar;

Step 6: tightly attaching the end surfaces of the mounting convex blocks 31 to the end surface of the annular protrusion mounting portion 44, and fixing the light-emitting mechanism 40 in the light-emitting mechanism mounting seat 30 through screws; subsequently, installing the rotation mechanism into the ball shaft 212, and fixing the refraction mechanism 60 to the output end of the rotation mechanism; tightly attaching the end surfaces of the connecting studs 12 to the end surfaces of the rigid nut column 22, and fixing the cover body 21 in the core frame 11 through screws; namely, enabling the level adjustment mechanism to effectively adjust the laser beam emitted by the present invention.

In the present invention, the level adjustment mechanisms are fixed in the core frame 11 before the end surfaces of the mounting convex blocks 31 in the light-emitting mechanism mounting seat 30 are processed. Thus, the adjustment result of the level adjustment mechanism can be directly fed back to the mounting convex blocks 31, preventing the assembling and processing errors from being accumulated. Therefore, greater assembly errors can be effectively avoided. Likewise, the end surfaces of the light-emitting mechanism 40 and the cover body 21 are processed after their semi-finished products are assembled. As the errors of every position can be significantly reduced, the present invention can be directly used without adjustment, and a higher accuracy of the laser collimation plane emitted by the present invention can be achieved.

In order to further improve the accuracy of the light-emitting mechanism 40 adjusted by the level adjustment mechanisms, in steps 3 and 4 of this embodiment, the diameter of the end surface of the mounting convex block 31 is defined as p, and the edge length of the milling cutter in the milling machine is defined as L, wherein p≤L. The width of the end surface of the annular protrusion mounting portion 44 is defined as q, and q≤L. By means of this design, the mounting convex blocks 31 and the annular protrusion mounting portion 44 can be formed in one cut, protecting the accuracy of the end surface from being affected due to a combined surface formed by multiple cuts.

In steps 3, 4 and 5 of this embodiment, the outer diameter of the surface to be processed can be designed according to the calculation formula j=i/tank, wherein i is the processing accuracy of the milling machine, which is normally 0.01 mm or 0.005 mm, j is the outer diameter of the surface to be processed, which is also the rotation diameter of the milling cutter or that of the surface to be processed, and k is the processing and forming accuracy. The processing accuracy can be selected according to actual need. Before designing the outer diameter of the surface to be processed, the accuracy of the finished product must be ensured to meet the requirement of 0≤k≤37″.

The description of above embodiments allows those skilled in the art to realize or use the present invention. Without departing from the spirit and essence of the present invention, those skilled in the art can combine, change or modify correspondingly according to the present invention. Therefore, the protective range of the present invention should not be limited to the embodiments above but conform to the widest protective range which is consistent with the principles and innovative characteristics of the present invention. Although some special terms are used in the description of the present invention, the scope of the invention should not necessarily be limited by this description. The scope of the present invention is defined by the claims.

1. A physical-adjustment-free laser level gauge, comprising:
a core assembly, and
a cover assembly, wherein the core assembly and the cover assembly are fixedly connected, wherein the core assembly further comprises a core frame, wherein m connecting studs are fixed to the core frame, wherein m is an integer larger than or equal to 3, wherein the core frame is provided with an x-axis level bubble, a y-axis level bubble and a z-axis level bubble, wherein the cover assembly further comprises a cover body, wherein m rigid nut columns are fixed in the cover body through sealing glue, wherein the rigid nut columns protrude from the cover body, and are connected with the connecting studs through screws, wherein
a light-emitting mechanism mounting seat is fixed on the core frame, and a light-emitting mechanism is connected with the light-emitting mechanism mounting seat through screws, wherein the light-emitting mechanism mounting seat is provided with n mounting convex blocks, wherein n is an integer larger than or equal to 3, wherein the mounting convex block is provided with a first screw hole, and the first screw hole extends throughout the mounting convex block and the core frame, wherein the light-emitting mechanism comprises a light source support shell and a light source that is fixed in the light source support shell, wherein an annular protrusion mounting portion is fixed on one side of the mounting disc that is far away from the light-emitting side of the light source, wherein an inner ring of the annular protrusion mounting portion is spaced from the light source support shell, wherein n second screw holes are formed in the annular protrusion mounting portion, wherein the second screw hole also extends throughout the mounting disc, and is matched with the first screw hole, wherein
a ball shaft mounting seat is arranged on the cover body, and a ball shaft is fixed in the ball shaft mounting seat, wherein a rotation mechanism is arranged in the ball shaft, and a refraction mechanism is fixed at the output end of the top of the rotation mechanism, wherein
the end surface of the connecting stud, the end surface of the rigid nut column, the end surface of the mounting convex block and the end surface of the annular protrusion mounting portion are parallel to the xy-plane, wherein the optical axis of the light source and the rotation axis of the rotation mechanism are parallel to the z-axis, and the optical axis of the light source is coaxial with the rotation axis of the rotation mechanism.

2. The physical-adjustment-free laser level gauge of claim 1, wherein the height of the mounting convex block that protrudes from the light-emitting mechanism mounting seat is 0.5-1 mm, wherein all mounting convex blocks are distributed in a circle with the diameter of P, wherein P≥27 mm.

3. The physical-adjustment-free laser level gauge of claim 1, wherein the height of the annular protrusion mounting portion that protrudes from the mounting disc is 3.5-4 mm, wherein the diameter of the outer ring of the annular protrusion mounting portion is larger than or equal to 27 mm.

4. The physical-adjustment-free laser level gauge of claim 1, wherein the rotation mechanism comprises a hollow rotation shaft, and a rotation disc is fixed to one end of the hollow rotation shaft that is close to the core assembly, wherein the other end of the hollow rotation shaft is the output end of the rotation mechanism, wherein the hollow rotation shaft is installed in the ball shaft through a bearing, wherein the rotation mechanism further comprises a rotation driving motor, and the output end of the rotation driving motor is connected with the rotation disc through a belt.

5. The physical-adjustment-free laser level gauge of claim 4, wherein the radius of the columnar inner cavity of the hollow rotation shaft is defined as R, and the radius of the light beam emitted by the light source is defined as r, wherein r≤R.

6. The physical-adjustment-free laser level gauge of claim 4, wherein a coding magnetic disk is fixed on the rotation disc, and a photoelectric sensor is arranged in the cover body, wherein the sensing portion of the photoelectric sensor is opposite to the coding magnetic disk.

7. The physical-adjustment-free laser level gauge of claim 1, wherein the ball end of the ball shaft is connected with a ball limiting block, and a clamping plate is arranged between the ball limiting block and the cover body, wherein the clamping plate is provided with a gourd-shaped notch, and the small-radius part of the notch is located in the center of the clamping plate, wherein the clamping plate is connected with the cover body through clamping connection mechanisms.

8. A method for assembling and processing the physical-adjustment-free laser level gauge of claim 1, comprising the steps of:
Step 1: obtaining the core frame, the cover body and the light-emitting mechanism through a machining process;
Step 2: fixing the x-axis level bubble, the y-axis level bubble and the z-axis level bubble in the core frame;
Step 3: placing the core frame into a milling machine, and leveling the core frame through the x-axis level bubble, the y-axis level bubble and the z-axis level bubble; subsequently, processing the end surfaces of the connecting studs and that of the mounting convex blocks via a milling process, thus enabling the end surfaces of the connecting studs and that of the mounting convex blocks to be parallel to the xy-plane;
Step 4: clamping the light-emitting mechanism into a rotary calibration device, and placing a CCD screen at a distance of 80-120 m away from the light-emitting mechanism; propelling the light-emitting mechanism to rotate through the rotary calibration device, and adjusting the position of the light-emitting mechanism until the projection of the rotating light-emitting mechanism on the CCD screen is changed from a circle into a dot, wherein the CCD screen obtains accurate images from a computer connected therewith, and the milling machine processes the end surface of the annular protrusion mounting portion of the light-emitting mechanism having an adjusted angle, thus ensuring that the end surface of the annular protrusion mounting portion is parallel to the xy-plane;
Step 5: fixing the ball shaft in the ball shaft mounting seat, and fixing the rigid nut columns in the cover body through sealing glue; subsequently, fixing the cover body in the milling machine through the interaction between the ball shaft and the clamping fixture, and processing the end surfaces of the rigid nut columns via a milling process, thus ensuring that the end surfaces of the rigid nut columns are parallel to the xy-plane;
Step 6: tightly attaching the end surfaces of the mounting convex blocks to the end surface of the annular protrusion mounting portion, and fixing the light-emitting mechanism in the light-emitting mechanism mounting seat through screws; subsequently, installing the rotation mechanism into the ball shaft, and fixing the refraction mechanism to the output end of the rotation mechanism; tightly attaching the end surfaces of the connecting studs to the end surfaces of the rigid nut column, and fixing the cover body in the core frame through screws.

9. The method for assembling and processing the physical-adjustment-free laser level gauge of claim 8, wherein in steps 3 and 4, the diameter of the end surface of the mounting convex block is defined as p, and the edge length of the milling cutter in the milling machine is defined as L, wherein p≤L, wherein the width of the end surface of the annular protrusion mounting portion is defined as q, and q≤L.

10. The method for assembling and processing the physical-adjustment-free laser level gauge of claim 8, wherein in steps 3, 4 and 5, the outer diameter of the surface to be processed can be designed according to the formula j=i/tank, wherein i is the processing accuracy of the milling machine, j is the outer diameter of the surface to be processed, and k is the processing and forming accuracy, wherein 0≤k≤37″.

11. A method for assembling and processing the physical-adjustment-free laser level gauge of claim 2, comprising the steps of:
Step 1: obtaining the core frame, the cover body and the light-emitting mechanism through a machining process;
Step 2: fixing the x-axis level bubble, the y-axis level bubble and the z-axis level bubble in the core frame;
Step 3: placing the core frame into a milling machine, and leveling the core frame through the x-axis level bubble, the y-axis level bubble and the z-axis level bubble; subsequently, processing the end surfaces of the connecting studs and that of the mounting convex blocks via a milling process, thus enabling the end surfaces of the connecting studs and that of the mounting convex blocks to be parallel to the xy-plane;
Step 4: clamping the light-emitting mechanism into a rotary calibration device, and placing a CCD screen at a distance of 80-120 m away from the light-emitting mechanism; propelling the light-emitting mechanism to rotate through the rotary calibration device, and adjusting the position of the light-emitting mechanism until the projection of the rotating light-emitting mechanism on the CCD screen is changed from a circle into a dot, wherein the CCD screen obtains accurate images from a computer connected therewith, and the milling machine processes the end surface of the annular protrusion mounting portion of the light-emitting mechanism having an adjusted angle, thus ensuring that the end surface of the annular protrusion mounting portion is parallel to the xy-plane;
Step 5: fixing the ball shaft in the ball shaft mounting seat, and fixing the rigid nut columns in the cover body through sealing glue; subsequently, fixing the cover body in the milling machine through the interaction between the ball shaft and the clamping fixture, and processing the end surfaces of the rigid nut columns via a milling process, thus ensuring that the end surfaces of the rigid nut columns are parallel to the xy-plane;
Step 6: tightly attaching the end surfaces of the mounting convex blocks to the end surface of the annular protrusion mounting portion, and fixing the light-emitting mechanism in the light-emitting mechanism mounting seat through screws; subsequently, installing the rotation mechanism into the ball shaft, and fixing the refraction mechanism to the output end of the rotation mechanism; tightly attaching the end surfaces of the connecting studs to the end surfaces of the rigid nut column, and fixing the cover body in the core frame through screws.

12. A method for assembling and processing the physical-adjustment-free laser level gauge of claim 3, comprising the steps of:
Step 1: obtaining the core frame, the cover body and the light-emitting mechanism through a machining process;
Step 2: fixing the x-axis level bubble, the y-axis level bubble and the z-axis level bubble in the core frame;
Step 3: placing the core frame into a milling machine, and leveling the core frame through the x-axis level bubble, the y-axis level bubble and the z-axis level bubble; subsequently, processing the end surfaces of the connecting studs and that of the mounting convex blocks via a milling process, thus enabling the end surfaces of the connecting studs and that of the mounting convex blocks to be parallel to the xy-plane;
Step 4: clamping the light-emitting mechanism into a rotary calibration device, and placing a CCD screen at a distance of 80-120 m away from the light-emitting mechanism; propelling the light-emitting mechanism to rotate through the rotary calibration device, and adjusting the position of the light-emitting mechanism until the projection of the rotating light-emitting mechanism on the CCD screen is changed from a circle into a dot, wherein the CCD screen obtains accurate images from a computer connected therewith, and the milling machine processes the end surface of the annular protrusion mounting portion of the light-emitting mechanism having an adjusted angle, thus ensuring that the end surface of the annular protrusion mounting portion is parallel to the xy-plane;
Step 5: fixing the ball shaft in the ball shaft mounting seat, and fixing the rigid nut columns in the cover body through sealing glue; subsequently, fixing the cover body in the milling machine through the interaction between the ball shaft and the clamping fixture, and processing the end surfaces of the rigid nut columns via a milling process, thus ensuring that the end surfaces of the rigid nut columns are parallel to the xy-plane;
Step 6: tightly attaching the end surfaces of the mounting convex blocks to the end surface of the annular protrusion mounting portion, and fixing the light-emitting mechanism in the light-emitting mechanism mounting seat through screws; subsequently, installing the rotation mechanism into the ball shaft, and fixing the refraction mechanism to the output end of the rotation mechanism; tightly attaching the end surfaces of the connecting studs to the end surfaces of the rigid nut column, and fixing the cover body in the core frame through screws.

13. A method for assembling and processing the physical-adjustment-free laser level gauge of claim 4, comprising the steps of:
Step 1: obtaining the core frame, the cover body and the light-emitting mechanism through a machining process;
Step 2: fixing the x-axis level bubble, the y-axis level bubble and the z-axis level bubble in the core frame;
Step 3: placing the core frame into a milling machine, and leveling the core frame through the x-axis level bubble, the y-axis level bubble and the z-axis level bubble; subsequently, processing the end surfaces of the connecting studs and that of the mounting convex blocks via a milling process, thus enabling the end surfaces of the connecting studs and that of the mounting convex blocks to be parallel to the xy-plane;
Step 4: clamping the light-emitting mechanism into a rotary calibration device, and placing a CCD screen at a distance of 80-120 m away from the light-emitting mechanism; propelling the light-emitting mechanism to rotate through the rotary calibration device, and adjusting the position of the light-emitting mechanism until the projection of the rotating light-emitting mechanism on the CCD screen is changed from a circle into a dot, wherein the CCD screen obtains accurate images from a computer connected therewith, and the milling machine processes the end surface of the annular protrusion mounting portion of the light-emitting mechanism having an adjusted angle, thus ensuring that the end surface of the annular protrusion mounting portion is parallel to the xy-plane;
Step 5: fixing the ball shaft in the ball shaft mounting seat, and fixing the rigid nut columns in the cover body through sealing glue; subsequently, fixing the cover body in the milling machine through the interaction between the ball shaft and the clamping fixture, and processing the end surfaces of the rigid nut columns via a milling process, thus ensuring that the end surfaces of the rigid nut columns are parallel to the xy-plane;
Step 6: tightly attaching the end surfaces of the mounting convex blocks to the end surface of the annular protrusion mounting portion, and fixing the light-emitting mechanism in the light-emitting mechanism mounting seat through screws; subsequently, installing the rotation mechanism into the ball shaft, and fixing the refraction mechanism to the output end of the rotation mechanism; tightly attaching the end surfaces of the connecting studs to the end surfaces of the rigid nut column, and fixing the cover body in the core frame through screws.

14. A method for assembling and processing the physical-adjustment-free laser level gauge of claim 5, comprising the steps of:
Step 1: obtaining the core frame, the cover body and the light-emitting mechanism through a machining process;
Step 2: fixing the x-axis level bubble, the y-axis level bubble and the z-axis level bubble in the core frame;
Step 3: placing the core frame into a milling machine, and leveling the core frame through the x-axis level bubble, the y-axis level bubble and the z-axis level bubble; subsequently, processing the end surfaces of the connecting studs and that of the mounting convex blocks via a milling process, thus enabling the end surfaces of the connecting studs and that of the mounting convex blocks to be parallel to the xy-plane;
Step 4: clamping the light-emitting mechanism into a rotary calibration device, and placing a CCD screen at a distance of 80-120 m away from the light-emitting mechanism; propelling the light-emitting mechanism to rotate through the rotary calibration device, and adjusting the position of the light-emitting mechanism until the projection of the rotating light-emitting mechanism on the CCD screen is changed from a circle into a dot, wherein the CCD screen obtains accurate images from a computer connected therewith, and the milling machine processes the end surface of the annular protrusion mounting portion of the light-emitting mechanism having an adjusted angle, thus ensuring that the end surface of the annular protrusion mounting portion is parallel to the xy-plane;
Step 5: fixing the ball shaft in the ball shaft mounting seat, and fixing the rigid nut columns in the cover body through sealing glue; subsequently, fixing the cover body in the milling machine through the interaction between the ball shaft and the clamping fixture, and processing the end surfaces of the rigid nut columns via a milling process, thus ensuring that the end surfaces of the rigid nut columns are parallel to the xy-plane;
Step 6: tightly attaching the end surfaces of the mounting convex blocks to the end surface of the annular protrusion mounting portion, and fixing the light-emitting mechanism in the light-emitting mechanism mounting seat through screws; subsequently, installing the rotation mechanism into the ball shaft, and fixing the refraction mechanism to the output end of the rotation mechanism; tightly attaching the end surfaces of the connecting studs to the end surfaces of the rigid nut column, and fixing the cover body in the core frame through screws.

15. A method for assembling and processing the physical-adjustment-free laser level gauge of claim 6, comprising the steps of:
Step 1: obtaining the core frame, the cover body and the light-emitting mechanism through a machining process;
Step 2: fixing the x-axis level bubble, the y-axis level bubble and the z-axis level bubble in the core frame;
Step 3: placing the core frame into a milling machine, and leveling the core frame through the x-axis level bubble, the y-axis level bubble and the z-axis level bubble; subsequently, processing the end surfaces of the connecting studs and that of the mounting convex blocks via a milling process, thus enabling the end surfaces of the connecting studs and that of the mounting convex blocks to be parallel to the xy-plane;
Step 4: clamping the light-emitting mechanism into a rotary calibration device, and placing a CCD screen at a distance of 80-120 m away from the light-emitting mechanism; propelling the light-emitting mechanism to rotate through the rotary calibration device, and adjusting the position of the light-emitting mechanism until the projection of the rotating light-emitting mechanism on the CCD screen is changed from a circle into a dot, wherein the CCD screen obtains accurate images from a computer connected therewith, and the milling machine processes the end surface of the annular protrusion mounting portion of the light-emitting mechanism having an adjusted angle, thus ensuring that the end surface of the annular protrusion mounting portion is parallel to the xy-plane;
Step 5: fixing the ball shaft in the ball shaft mounting seat, and fixing the rigid nut columns in the cover body through sealing glue; subsequently, fixing the cover body in the milling machine through the interaction between the ball shaft and the clamping fixture, and processing the end surfaces of the rigid nut columns via a milling process, thus ensuring that the end surfaces of the rigid nut columns are parallel to the xy-plane;
Step 6: tightly attaching the end surfaces of the mounting convex blocks to the end surface of the annular protrusion mounting portion, and fixing the light-emitting mechanism in the light-emitting mechanism mounting seat through screws; subsequently, installing the rotation mechanism into the ball shaft, and fixing the refraction mechanism to the output end of the rotation mechanism; tightly attaching the end surfaces of the connecting studs to the end surfaces of the rigid nut column, and fixing the cover body in the core frame through screws.

16. A method for assembling and processing the physical-adjustment-free laser level gauge of claim 7, comprising the steps of:
Step 1: obtaining the core frame, the cover body and the light-emitting mechanism through a machining process;
Step 2: fixing the x-axis level bubble, the y-axis level bubble and the z-axis level bubble in the core frame;
Step 3: placing the core frame into a milling machine, and leveling the core frame through the x-axis level bubble, the y-axis level bubble and the z-axis level bubble; subsequently, processing the end surfaces of the connecting studs and that of the mounting convex blocks via a milling process, thus enabling the end surfaces of the connecting studs and that of the mounting convex blocks to be parallel to the xy-plane;
Step 4: clamping the light-emitting mechanism into a rotary calibration device, and placing a CCD screen at a distance of 80-120 m away from the light-emitting mechanism; propelling the light-emitting mechanism to rotate through the rotary calibration device, and adjusting the position of the light-emitting mechanism until the projection of the rotating light-emitting mechanism on the CCD screen is changed from a circle into a dot, wherein the CCD screen obtains accurate images from a computer connected therewith, and the milling machine processes the end surface of the annular protrusion mounting portion of the light-emitting mechanism having an adjusted angle, thus ensuring that the end surface of the annular protrusion mounting portion is parallel to the xy-plane;
Step 5: fixing the ball shaft in the ball shaft mounting seat, and fixing the rigid nut columns in the cover body through sealing glue; subsequently, fixing the cover body in the milling machine through the interaction between the ball shaft and the clamping fixture, and processing the end surfaces of the rigid nut columns via a milling process, thus ensuring that the end surfaces of the rigid nut columns are parallel to the xy-plane;
Step 6: tightly attaching the end surfaces of the mounting convex blocks to the end surface of the annular protrusion mounting portion, and fixing the light-emitting mechanism in the light-emitting mechanism mounting seat through screws; subsequently, installing the rotation mechanism into the ball shaft, and fixing the refraction mechanism to the output end of the rotation mechanism; tightly attaching the end surfaces of the connecting studs to the end surfaces of the rigid nut column, and fixing the cover body in the core frame through screws.
